(19) United States
(12) Patent Application Publication
(10) Pub. No.: US 2009/0273437 A1
(43) Pub. Date: Nov. 5, 2009

(54) KEY-OPERATED SWITCH

(75) Inventors: Hans-Georg Kopken, Erlangen (DE); Christiane Muller, Baiersdorf (DE); Richard Schmidt, Baiersdorf (DE); Gunter Schwesig, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/432,317

(22) Filed: Apr. 29, 2009

(30) Foreign Application Priority Data
Apr. 30, 2008 (EP) 08008284.5

(51) Int. Cl. G05B 19/00

(52) U.S. Cl. 340/5.6

(57) ABSTRACT

A key-operated switch includes a first excitation device which generates a first alternating magnetic field and has a first inductance. The key-operated switch is constructed in such a manner that the first alternating magnetic field can be used to scan a first coding of a key, with the first coding changing the first inductance of the first excitation device. The first coding is read by the key-operated switch in this manner. The key associated with the key-operated switch has a carrier element which is not electrically conductive and is not magnetizable. Arranged on the carrier element is the first coding which is made of an electrically conductive and/or magnetizable material. As a result, the key can be scanned without wear.

### CROSS-REFERENCES TO RELATED APPLICATIONS

This application claims the priority of European Patent Application, Serial No. 08008284, filed Apr. 30, 2008, pursuant to 35 U.S.C. 119(a)-(d), the content of which is incorporated herein by reference in its entirety as if fully set forth herein.

### BACKGROUND OF THE INVENTION

The present invention relates to a key-operated switch and to a key associated with the key-operated switch.

The following discussion of related art is provided to assist the reader in understanding the advantages of the invention, and is not to be construed as an admission that this related art is prior art to this invention.

FIG. 1 illustrates a commercially available operating device 1 for operating a machine from automation technology, for example a machine tool, a production machine and/or a robot, which has a commercially available mechanical key-operated switch 2. In the case of mechanical key-operated switches, the key is mechanically scanned. However, mechanical key-operated switches have the disadvantage that dirt which often occurs in an automation environment and is usually in the form of liquids, dust particles or aggressive gases can be introduced into the operating device via the key-operated switch and can result in malfunctions there. Furthermore, the mechanical system of the key-operated switch itself may also be damaged.

Furthermore, owing to the moving mechanical parts, mechanical key-operated switches are subject to a high degree of wear and are relatively easy to manipulate.

Instead of a key-operated switch, other identification systems are also used, for example contactless RFID systems. However, these systems are relatively complicated and expensive.

It would therefore be desirable and advantageous to provide an improved key-operated switch to obviate prior art shortcomings and to allow scanning of a key without wear.

### SUMMARY OF THE INVENTION

According to one aspect of the present invention, a key-operated switch, comprising a first excitation device which generates a first alternating magnetic field to scan a first coding of a key as the key is inserted in an insertion direction and which has a first inductance, wherein the first inductance of the first excitation device changes in response to a scanning of the first coding to thereby allow reading of the first coding.

According to another aspect of the present invention, a key associated with a key-operated switch of the invention includes a carrier element which is not electrically conductive and not magnetizable, and a first coding made of an electrically conductive and/or magnetizable material and arranged on the carrier element.

According to another advantageous feature of the present invention, the first excitation device may be constructed to serially read the first coding as the key is inserted. As a result, there is need for only a single excitation device to read the first coding of the key.

According to another advantageous feature of the present invention, the key-operated switch may include a plurality of excitation devices which are arranged behind one another in the insertion direction of the key to read the first coding in a parallel manner. In this way, the first coding can be read in a rapid and particularly reliable manner.

According to another advantageous feature of the present invention, the key-operated switch may include a second excitation device which generates a second alternating magnetic field to scan a second coding of the key and which has a second inductance, wherein the second alternating magnetic field changes in response to a scanning of the second coding to thereby allow reading of the second coding, wherein the first coding and the second coding are read simultaneously, with the first coding determining a position of the key, as the key is inserted. The use of two codings ensures a particularly high level of security against impermissible manipulation of the key-operated switch.

According to another advantageous feature of the present invention, the first excitation device may include a yoke and a coil wound around the yoke. This is a particularly simple implementation of the first excitation device.

According to another advantageous feature of the present invention, the coil may be constructed in the form of a planar coil. Implementing the coil in the form of a planar coil is a type of implementation of the coil which is particularly simple to produce.

According to another advantageous feature of the present invention, the first coding may be made of an electrically conductive and/or magnetizable material. An electrically conductive and/or magnetizable material influences the alternating magnetic field in an effective manner. The first coding may also be realized in the form of binary coding, bar coding, multilevel coding or analog coding since these codings are simple to implement. Suitable, the second coding may be implemented in the form of analog coding. This achieves a particularly high level of security against manipulation of the key-operated switch.

According to another advantageous feature of the present invention, the key-operated switch may include a front panel having an opening for inserting the key, and a separating element which is not electrically conductive and not magnetizable and which is arranged adjacent to the opening on an inside of the key-operated switch to physically separate the opening from the first excitation device. In this way, dirt is reliably prevented from entering the key-operated switch and from ingress through the key-operated switch into the interior of the operating device.

According to another advantageous feature of the present invention, the key-operated switch may include a front panel having an opening for inserting the key, and a separating element which is not electrically conductive and not magnetizable and which is arranged adjacent to the opening on an inside of the key-operated switch to physically separate the opening from the first and second excitation devices. This reliably prevents dirt from entering the key-operated switch and from ingress through the key-operated switch into the interior of the operating device.

According to another advantageous feature of the present invention, there is provided a second coding which is made of electrically conductive and/or magnetizable material and applied to the carrier element. The use of two codings ensures a particularly high level of security against impermissible manipulation of the key. The first coding may hereby be implemented in the form of binary coding, bar coding, multilevel coding or analog coding whereas the second coding may be implemented in the form of analog coding.

According to another advantageous feature of the present invention, the first coding may be covered with an opaque layer. This makes it difficult to copy the key. Suitably, also the second coding may be covered with an opaque layer. This makes it even harder to copy the key.

According to another advantageous feature of the present invention, the key-operated switch may include a plurality of access codes, wherein a match between an access code with a reading of the first coding and/or the second coding causes output of an access signal which is associated with the access code. As a result, only standard applications can be enabled with a key owned by a normal user, for example, whereas advanced, for example more hazardous, operating actions which may be carried out only by specialist staff can be enabled with another key owned only by a specialist.

According to yet another aspect of the present invention, an operating device for operating a machine and/or a system from automation technology, includes a key-operated switch including a first excitation device which generates a first alternating magnetic field to scan a first coding of a key as the key is inserted in an insertion direction and which has a first inductance, wherein the first inductance of the first excitation device changes in response to a scanning of the first coding to thereby allow reading of the first coding. This provides an operating device which is insensitive to dirt.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an operating device having a mechanical key-operated switch which is known from the prior art;

FIG. 2 is a schematic illustration of a one exemplary embodiment of a key-operated switch according to the invention, depicting a coding being serially read by the key-operated switch as a key is inserted;

FIG. 3 is a schematic illustration of a separating element for separating the electronics of the key-operated switch from an opening of the key-operated switch;

FIG. 4 shows a key having multilevel coding,

FIG. 5 shows an evaluation unit for evaluating a multilevel coding,

FIG. 6 is a schematic illustration of another exemplary embodiment of a key-operated switch according to the invention for reading a key with binary coding in a parallel manner,

FIG. 7 shows an evaluation unit for evaluating a coding in a parallel manner,

FIG. 8 is a schematic illustration of yet another exemplary embodiment of a key-operated switch according to the invention for a key with two codings,

FIG. 9 shows an evaluation unit for a key with two codings,

FIG. 10 shows a key with bar coding, and

FIG. 11 shows a key in which the coding is covered with an opaque layer.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

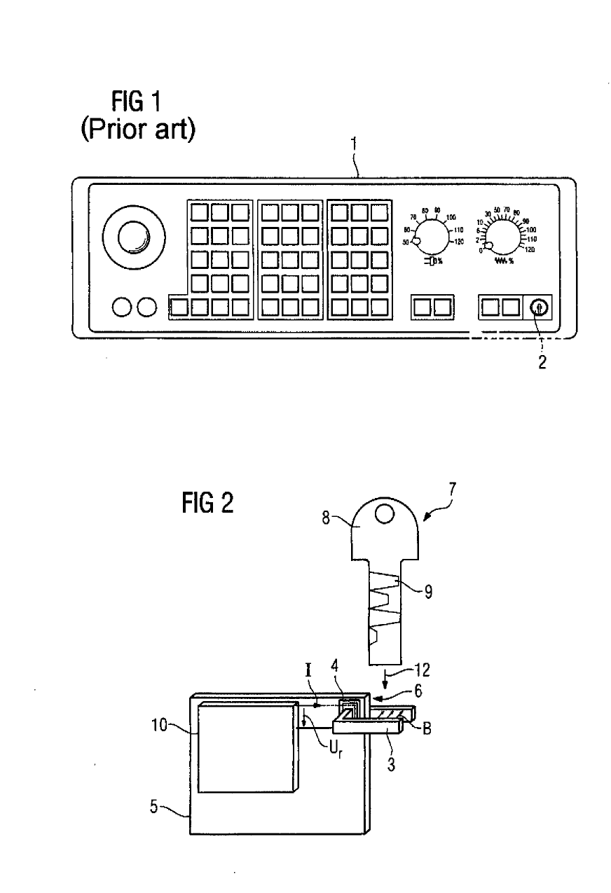

Turning now to the drawing, and in particular to FIG. 2, there is shown a schematic illustration of a first exemplary embodiment of a key-operated switch according to the invention. FIG. 2 shows only the essential electrical components of the key-operated switch and it will be appreciated by persons skilled in the art that the key-operated switch must contain much mechanical apparatus which does not appear in the FIG. 2. However, this apparatus, like much other necessary apparatus, is not part of the invention, and has therefore been omitted for the sake of simplicity. The key-operated switch has a first excitation device 6 which generates a first alternating magnetic field B and has a first inductance L of a few millihenries, for example. The excitation device 6 comprises a coil, which is in the form of a planar coil 4 within the scope of the exemplary embodiment, and a yoke 3 which is preferably horseshoe-shaped and is composed of ferrite within the scope of the exemplary embodiment. In this case, the excitation device 6, that is to say the planar coil 4 together with the yoke 3, has a first inductance L, as already mentioned above. The planar coil 4 is arranged, together with an evaluation unit 10, on a printed circuit board 5. The evaluation unit 10 generates an AC voltage Uᵣ, as a result of which an alternating current I flows through the planar coil 4 according to the relationship

$$I = \frac{{U}_{r}}{2 π fL}$$

wherein
L is the inductance, and
f is the frequency of the alternating current.

The planar coil 4 consequently generates, together with the yoke 3, an alternating magnetic field B, that is to say a magnetic field which changes over time.

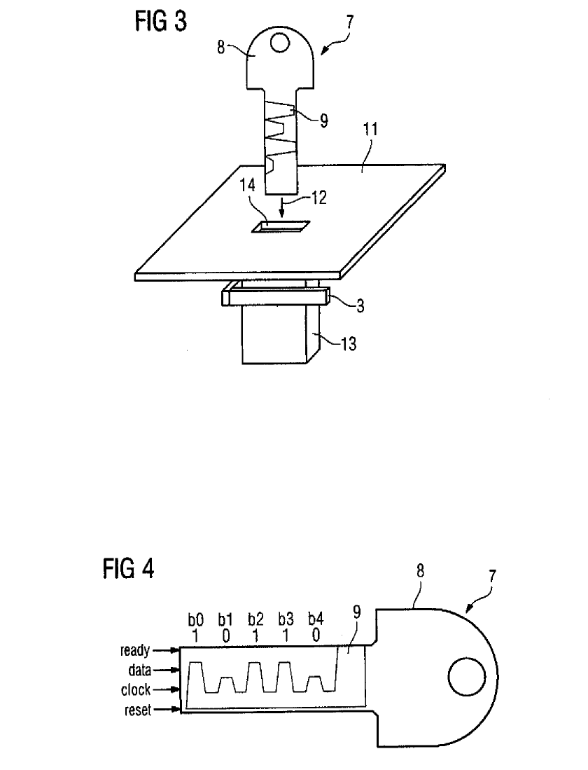

The top of FIG. 2 illustrates a corresponding key 7 associated with the key-operated switch. The key 7 comprises a carrier element 8 which is not conductive and not magnetizable and to which a first coding 9 made of an electrically conductive and/or magnetizable material is applied. During an operation of inserting the key into the key-operated switch, which is illustrated by an arrow 12, the first coding 9 is serially read by the key-operated switch by using the first magnetic field B to scan the first coding 9 applied to the key 7 by means of the first alternating magnetic field B. In this case, in the illustration according to FIG. 2, the first coding 9 is led, from top to bottom, through the yoke 3 and thus through the alternating magnetic field B. The first coding 9 changes the first inductance L of the first excitation device 6, as a result of which the first coding 9 is read by the key-operated switch in this manner. As already stated, the first coding 9 changes the inductance L of the excitation device 6, as a result of which the current I changes, which is evaluated by the evaluation device 10. For this purpose, the evaluation unit 10 measures the alternating current I which, as already stated, changes according to the first coding as the key is inserted into the key-operated switch. Within the scope of the first exemplary embodiment, the first coding 9 is in the form of multilevel coding in this case. Whereas FIG. 2 essentially illustrates the electronics of the key-operated switch, FIG. 3 essentially illustrates the passive components of the key-operated switch. The key-operated switch has a front panel 11 having an opening 14 for inserting the key 7. As the key 7 is inserted, the key is led through the opening 14, which is illustrated by an arrow 12. On the inside of the key-operated switch, the key-operated switch has a separating element 13 which is not electrically conductive and is not magnetizable, said element being arranged at the opening and completely physically separating the key from the first excitation device. Within the scope of the exemplary embodiment, the separating element 13 is in the form of a cuboidal hollow body whose cavity is open only toward the top in the direction of the opening 14. In this manner, the separating element 13 forms a blind hole through which no dirt, which enters through the opening 14, can advance to the electronics (illustrated in FIG. 2) of the key-operated switch. In this case, the separating element 13 preferably separates the opening 14 from the excitation device 6 in an airtight manner. In this case, the separating element 13 is arranged such that it is led through the horseshoe-shaped yoke 3.

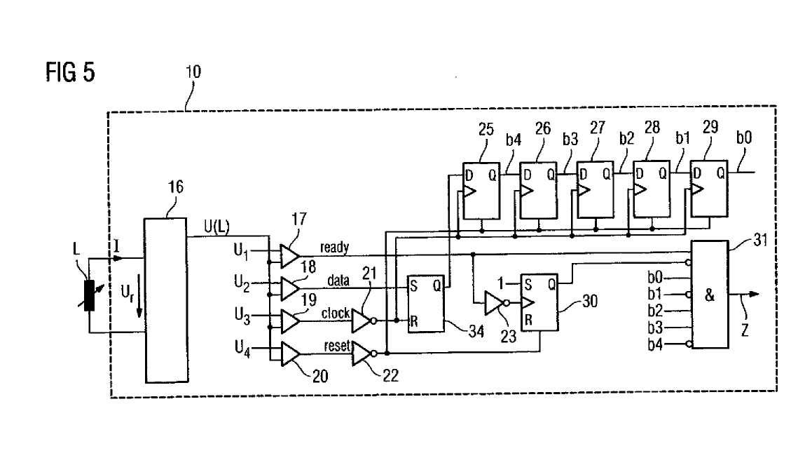

FIG. 4 illustrates, in detail, a key 7 with a first coding 9 which is in the form of multilevel coding. In contrast to binary coding, multilevel coding has a plurality of levels which are evaluated by the evaluation unit 10 when exceeded. Within the scope of the exemplary embodiment, these are the four levels of reset, clock, data and ready which correspond to a certain level in the design of the first coding 9 which is peg-shaped in FIG. 4.

FIG. 5 illustrates, in detail, the evaluation unit associated with multilevel coding. In this case, the evaluation unit 10 has an excitation unit 16 which generates the AC voltage Uᵣ. As already stated above, an alternating current I is produced through the planar coil 4. The first excitation device 6 has an inductance L of a few millihenries which changes as the first coding 9 is led through the magnetic field B (the changing inductance L is symbolically illustrated in FIG. 5 by a black rectangle with an oblique arrow). This accordingly changes the alternating current I which is measured by the excitation unit 16. The first coding 9 is inductively scanned in this manner using the alternating magnetic field B. On the output side, the excitation unit 16 generates, according to the changing current I and thus according to the changing inductance L, a correspondingly changing output voltage U(L). The output voltage U(L) is compared with different voltages U1, U2, U3 and U4 by means of comparators 17, 18, 19 and 20. If the voltage U(L) exceeds the voltage U1, the signal ready is set to logic “1”, if the voltage U(L) exceeds the voltage U2, the signal data is set to logic “1”, if the voltage U(L) exceeds the voltage U3, the signal clock is set to logic “1”, and if the voltage U(L) exceeds the voltage U4, the signal reset is set to logic “1”.

If a key has not been inserted, the signal reset clears the flip-flops 25-29 which form a shift register. As the key according to FIG. 4 is inserted, the first tooth b0 of the key 7 results in the flip-flop 34 being set via the signal data. The trailing edge of the tooth results in a falling edge of the signal clock, which results in the data bit being carried over from flip-flop 34 to the flip-flop 25 of the shift register and in the flip-flop 34 being cleared. The next tooth b1 of the key does not result in the flip-flop 34 being set, with the result that, upon the next trailing edge of the tooth, a zero is carried over to the flip-flop 25 of the shift register and b0 is simultaneously forwarded from flip-flop 25 to flip-flop 26 in the shift register.

If the key has been inserted fully, the rising edge of the signal ready results in the code checker 31 being enabled. If all of the bits which have been read in have the correct value in the shift register, the output Z of the code checker 31 is set to logic “1” and the validity of the key is thus reported.

As soon as the key is withdrawn, even only slightly, the falling edge of the signal ready results in the flip-flop 30 being set, said flip-flop blocking code checking. Only after the key has been completely removed does the signal reset clear the blocking flip-flop 30 again.

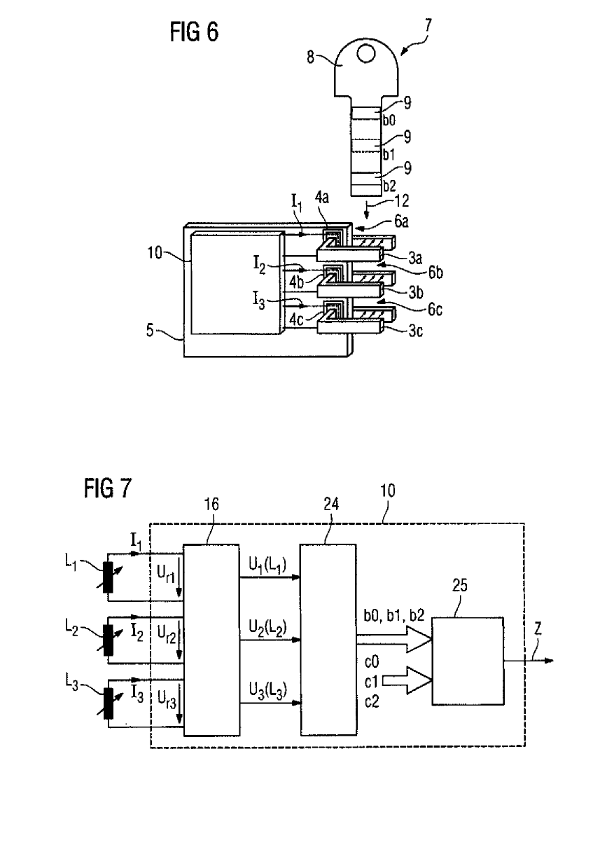

FIG. 6 illustrates an exemplary embodiment of the invention which makes it possible to read the first coding in a parallel manner. In contrast to the serial reading of the first coding as illustrated in FIG. 2, in which only a single excitation device 6 is needed, a plurality of first excitation devices are needed during parallel reading. Within the scope of the exemplary embodiment, the key-operated switch in FIG. 6 in this case has the three first excitation devices 6a, 6b and 6c with the respectively associated planar coils 4a, 4b and 4c and the respectively associated yokes 3a, 3b and 3c. In this case, the method of operation of each first excitation device is identical to that of the first excitation device 6 described and illustrated in FIG. 2, and the evaluation unit 10 evaluates the magnitude of the currents I₁ and I₂ and I₃ in an analogous manner, which is described in detail in FIG. 7. The top of FIG. 6 also illustrates a key 7 to whose carrier element 8 a first coding 9 is applied, the first coding being in the form of binary coding. For this purpose, at the positions at which the first excitation arrangements subsequently scan the key, the first coding 9 either has an electrically conductive and/or magnetizable region, or such a region is not provided at the relevant location, which is illustrated using dashed lines in FIG. 6. A region which has been provided corresponds, for example, to a logic “1”, whereas a region which has not been provided corresponds, for example, to a logic “0” or vice versa.

FIG. 7 illustrates the evaluation unit 10 associated with parallel reading. In this case, the first excitation device 6a has the inductance L₁, the first excitation device 6b has the inductance L₂ and the first excitation device 6c has the inductance L₃. The inductances L₁, L₂ and L₃ then change again in a manner corresponding to the first coding 9 of the key 7. The excitation unit 16 generates the AC voltages Uᵣ₁, Uᵣ₂ and Uᵣ₃, with the result that the alternating currents I₁, I₂ and I₃ change in a manner corresponding to the changing inductances L₁, L₂ and L₃, which is evaluated in the excitation unit 16. In a manner corresponding to the changing inductances L₁, L₂ and L₃, the excitation unit 16 then generates the voltages U₁(L₁), U₂(L₂) and U₃(L₃) which are respectively associated with the inductances L₁, L₂ and L₃ and are supplied to a comparator 24 as an input variable. The comparator 24 then compares the three voltages U₁(L₁), U₂(L₂) and U₃(L₃) with an internal reference voltage, a logic “1” or alternatively a logic “0” being generated, for example, when the reference voltage is exceeded. Each of the three voltages U₁(L₁), U₂(L₂) and U₃(L₃) is compared with the internal reference voltage in this manner and the binary output signals b0, b1 and b2 are accordingly generated in a parallel manner. These output signals are supplied, as an input variable, to a comparator 25 which compares them with the binary numbers c0, c1 and c2 which represent the access code within the scope of the exemplary embodiment. If there is a match, the comparator 25 sets an access signal Z to logic “1” on the output side and the key is thus identified as being suitable. The access signal Z can then be used to drive a relay, for example, or may be directly read in by an operating device and/or a controller and/or a regulating device, for example.

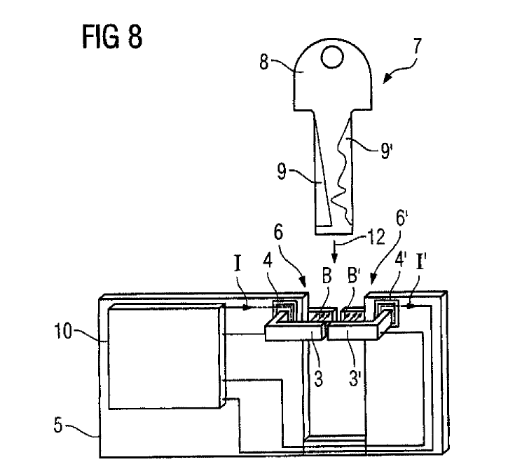

FIG. 8 illustrates another exemplary embodiment of the invention in which two codings are simultaneously read in in a serial manner.

In this case, a first coding 9 and a second coding 9′ are applied to the carrier element 8 of the key 7 on both sides of the key. In this case, the first coding 9 and the second coding 9′ are in the form of analog codings within the scope of the exemplary embodiment. In this case, the first coding 9 is in the form of a position track in order to detect the instantaneous position of the key in the key-operated switch during the operation of inserting the key, whereas the second coding 9′ is in the form of any desired curve. In terms of the method of operation, the embodiment according to FIG. 8 corresponds to the embodiment according to FIG. 2 but, in contrast to the embodiment according to FIG. 2, there is a second excitation device 6′ with a second planar coil 4′ and a second yoke 3′. In this case, the first coding 9 and the second coding 9′ are simultaneously read, the first coding 9 being used to detect the position at which the key is currently situated while the key is being inserted into the key-operated switch, and the second coding 9′ thus being able to be evaluated in a corresponding manner. The first coding 9 effectively contains the information of the bit number, whereas the second coding 9′ contains the associated bit value.

Otherwise, the method of operation corresponds to that of the embodiment which has already been illustrated in FIG. 2, the evaluation unit 10 processing the alternating currents I and I′ from the first excitation device 6 and from the second excitation device 6′ at the same time.

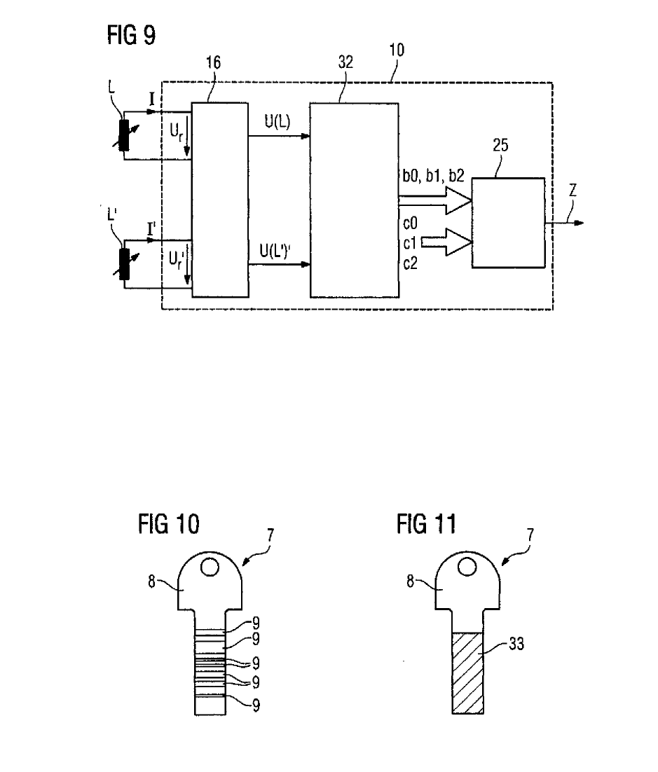

FIG. 9 schematically illustrates the evaluation unit 10 associated with the embodiment according to FIG. 8. The first excitation device 6 has the inductance L which changes as the key is inserted, whereas the second excitation device 6′ has the inductance L′ which may be changed as the key is inserted. In a manner similar to that in the previous examples which have already been described, the excitation unit 16 generates the two voltages Uᵣ and Uᵣ′, thus producing the two alternating currents I and I′ through the respectively associated planar coil 4 and 4′. On the output side, the excitation unit 16 generates the voltages U(L) and U(L′)′ in a manner corresponding to the changed alternating currents I and I′ by evaluating the inductances L and L′ which are changed as the key is inserted, the voltage U(L) reflecting the first coding 9, whereas the output voltage U(L ) reflects the second coding 9′. The two voltages U(L) and U(L′)′ are evaluated by a decoder 32 which reads in the voltages U(L) and U(L′)′ and combines the two voltages with one another, the first coding providing the bit number (position information), whereas the second coding provides the bit value associated with the bit number. The decoder 32 can infer the bit number from the first coding 9 in this manner, whereas it can infer the associated bit value from the second coding 9′. On the output side, the decoder 32 outputs the corresponding bits b0, b1 and b2 which have been determined in this manner and are then compared with the access code c0, c1 and c2, which is in the form of individual bits for example, using the comparator 25. If there is a match, the comparator 25 sets the access signal Z to logic “1”. In this case, the first coding 9 and the second coding 9′ are preferably evaluated in quantized form, that is to say, if, for example, the second coding 9′ exceeds a certain level at a position, a logic “1” is detected and, if a certain level is undershot, a logic “0” is detected or vice versa.

FIG. 10 illustrates another embodiment of the key 7 in which a first coding 9 in the form of bar coding is applied to the carrier element 8. In this case, the bar coding can be evaluated, for example, using the evaluation unit 10 illustrated in FIG. 2 and FIG. 5 but the voltage U(L) output by the excitation unit 16 on the output side is evaluated by a downstream bar decoder, which decodes the bar code, and the bar code which has been decoded in this manner is then compared with the access code using a comparator. If there is a match, the access signal Z at the output of the comparator is then again set to logic “1”.

FIG. 11 schematically illustrates an advantageous embodiment of the key which can be used for all of the preceding possible keys described with all of the codings described. In the case of the key according to FIG. 11, the coding is covered with an opaque layer 33 according to the invention, with the result that the coding can no longer be optically detected from the outside. This makes it difficult to copy the key. Otherwise, the key according to FIG. 11 corresponds to the keys described above. The same elements have therefore been provided with the same reference symbols as in the preceding figures.

The key-operated switch according to the invention makes it possible to achieve a high level of protection against contamination. Furthermore, the coding is scanned without wear, thus enabling a long service life of the key-operated switch and the key. Furthermore, the key-operated switch requires only a small amount of space. Since the key-operated switch reads the coding solely using an alternating magnetic field, it has a high level of immunity to electromagnetic interference coming from radio transmission systems, for example. Furthermore, the level of security against manipulation is very high. The key-operated switch can also be easily parameterized for different keys using software, for example. Furthermore, the key function can be combined with an electromechanical switching function. Furthermore, different keys having different codings can be used to enable different operating actions. For example, only standard applications can be enabled with a key owned by a normal user, whereas advanced, for example more hazardous, operating actions which may be carried out only by specialist staff are enabled with another key owned only by a specialist. For this purpose, the key-operated switch may have, for example, a plurality of code checkers 31 and/or comparators 25 which are connected in parallel, for example, and each check a different access code and output a respectively associated access signal.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A key-operated switch, comprising a first excitation device which generates a first alternating magnetic field to scan a first coding of a key as the key is inserted in an insertion direction and which has a first inductance, wherein the first inductance of the first excitation device changes in response to a scanning of the first coding to thereby allow reading of the first coding.

2. The key-operated switch of claim 1, wherein the first excitation device is constructed to serially read the first coding as the key is inserted.

3. The key-operated switch of claim 1, further comprising a plurality of said excitation device arranged behind one another in the insertion direction of the key to read the first coding in a parallel manner.

4. The key-operated switch of claim 1, further comprising a second excitation device generating a second alternating magnetic field to scan a second coding of the key and having a second inductance, wherein the second alternating magnetic field changes in response to a scanning of the second coding to thereby allow reading of the second coding, wherein the first coding and the second coding are read simultaneously, with the first coding determining a position of the key, as the key is inserted.

5. The key-operated switch of claim 1, wherein the first excitation device includes a yoke and a coil wound around the yoke.

6. The key-operated switch of claim 5, wherein the coil is constructed in the form of a planar coil.

7. The key-operated switch of claim 1, wherein the first coding is made of an electrically conductive and/or magnetizable material.

8. The key-operated switch of claim 1, wherein the first coding is implemented in the form of binary coding, bar coding, multilevel coding or analog coding.

9. The key-operated switch of claim 4, wherein the second coding is implemented in the form of analog coding.

10. The key-operated switch of claim 1, further comprising a front panel having an opening for inserting the key, and a separating element which is not electrically conductive and not magnetizable and which is arranged adjacent to the opening on an inside of the key-operated switch to physically separate the opening from the first excitation device.

11. The key-operated switch of claim 4, further comprising a front panel having an opening for inserting the key, and a separating element which is not electrically conductive and not magnetizable and which is arranged adjacent to the opening on an inside of the key-operated switch to physically separate the opening from the first and second excitation devices.

12. The key-operated switch of claim 4, further comprising a plurality of access codes, wherein a match between an access code with a reading of at least one member selected from the group consisting of the first coding and the second coding causes output of an access signal which is associated with the access code.

13. A key, comprising:
a carrier element which is not electrically conductive and not magnetizable; and
a first coding made of an electrically conductive and/or magnetizable material and arranged on the carrier element.

14. The key of claim 13, further comprising a second coding made of electrically conductive and/or magnetizable material and applied to the carrier element.

15. The key of claim 13, wherein the first coding is implemented in the form of binary coding, bar coding, multilevel coding or analog coding.

16. The key of claim 14, wherein the second coding is implemented in the form of analog coding.

17. The key of claim 13, further comprising an opaque layer covering the first coding.

18. The key of claim 14, further comprising an opaque layer covering the second coding.

19. An operating device for operating a machine and/or a system from automation technology, said operating device comprising a key-operated switch including a first excitation device which generates a first alternating magnetic field to scan a first coding of a key as the key is inserted in an insertion direction and which has a first inductance, wherein the first inductance of the first excitation device changes in response to a scanning of the first coding to thereby allow reading of the first coding.
